(19) United States
(12) Patent Application Publication
(10) Pub. No.: US 2007/0142185 A1
(43) Pub. Date: Jun. 21, 2007

(54) Walking training apparatus

(76) Inventors: Teresa Woodman, Austin, TX (US); Lisa Raper, Austin, TX (US)

Correspondence Address: ANTHONY EDW. J CAMPBELL, PO BOX 160370, AUSTIN, TX, 78716, US

(21) Appl. No.: 11/314,377

(22) Filed: Dec. 21, 2005

(51) Int. Cl. A61H 3/00; A47D 13/04; A63B 22/00

(52) U.S. Cl. 482/69

(57) ABSTRACT

A walking training apparatus having a support vest, the support vest is adapted to be fitted around the torso of an infant, the support vest having a left bell shaped attachment projection, the support vest having a right bell shaped attachment projection, a left upper strap connected to the support vest top end left bell shaped attachment projection and a right upper strap connected to the support vest top end right bell shaped attachment projection.

### BACKGROUND OF THE INVENTION

1. Field of the Invention

The present embodiment of the invention relates to a walking training apparatus for use in connection with devices used to train infants to walk. The walking training apparatus has particular utility in connection with a walking training apparatus having adjustable detachable handles and a bell shaped attachment projection.

Currently, training an infant to walk requires an attendant to hover in a stooped position over the infant to insure that no injury occurs during the inevitable falls that will occur during learning to walk. The pain associated with learning to walk increases the frustration level for the infant and hampers the training. Additionally, the leaning over of the infant to prevent injuries can harm the back of the attendant. Current solutions to this problem restrict the shoulder movement of the infant and have a single point of contact from the handle to the harness thus increasing the snap back that the infant feels when kept from falling which poses a safety hazard. Additionally, current solutions have a non-removable handle that the child drags with him when crawling off on his own to play.

Therefore, what is needed is a walking training apparatus that distributes the restraining force over a wide area thus restricting snap back, which has a removable handle that can be adjusted for length.

2. Description of Prior Art

Walking training apparatus are desirable training an infant to walk with reduced chance of injury for the infant and reduced chance of back injury for the attendant.

The use of devices used to train infants to walk is known in the prior art. For example, U.S. Pat. No. 1,749,999 to Crocker discloses a manually held supporting device for assisting children in learning to walk that as a torso harness, set of non-adjustable handle straps having single attachment points and shoulder straps. However, the Crocker '999 patent does not have a bell shaped set of handle strap attachment, does not have a removable handle, and does not have an adjustable handle strap.

Similarly, United States Document Number 2003/0207737 to Sherman et al. discloses a walking training apparatus that has a body portion having a closed side with leg openings, shoulder straps and a single handle. However, the Sherman et al '737 document does not have bell shaped handle strap attachment and does not have an adjustable handle strap. The Sherman et al '737 document teaches a single attachment point that is circular and which could catch on objects when the infant is away from the attendant, additionally the document teaches shoulder straps and does not use under arm support to restrain the infant from falling.

Likewise, U.S. Pat. No. 5,388,551 to Martusciello discloses a convertible harness system having a waist encircling band and shoulder straps. However, the Martusciello '551 patent does not have bell shaped handle strap attachments and does not have an adjustable handle strap.

Correspondingly, U.S. Pat. No. 149,692 to Tardy discloses a baby exercising corset that has a corset having two long cords connected to the corset. However, the Tardy '692 patent does not have bell shaped handle strap attachments and does not have an adjustable handle strap and does not have a detachable handle.

Further, U.S. Pat. No. 6,910,993 to Baran discloses a device for use in teaching infants to walk that has a support pant having support straps connected to the pant. However, the Baran '993 patent does not have bell shaped handle strap attachments and does not have a detachable handle.

Lastly, United States Document Number 200/0207736 to Mungia discloses an infant walker trainer that has a lateral support bar adapted to be secured around the stomach and chest area of the infant and a handle at the upper end of the support bar to guide the trainer. However, the Mungia '736 document does not does not have bell shaped handle strap attachments and does not have a detachable handle.

While the above-described devices fulfill their respective, particular objectives and requirements, the aforementioned patents do not describe a walking training apparatus that allows walking training apparatus having adjustable detachable handles and bell shaped attachments for the handle strap. The Crocker '999, Sherman et al '737, Martusciello '551, Tardy '692, Baran '993 and Mungia '736 patents make no provision for bell shaped handle strap attachments.

Therefore, a need exists for a new and improved walking training apparatus which can be used for walking training apparatus having adjustable detachable handles. In this regard, the present embodiment of the invention substantially fulfills this need. In this respect, the walking training apparatus according to the present embodiment of the invention substantially departs from the conventional concepts and designs of the prior art, and in doing so provides an apparatus primarily developed for the purpose of walking training apparatus having adjustable detachable handles and bell shaped attachments for the handle strap.

### SUMMARY OF THE INVENTION

The walking training apparatus of the present invention has a torso harness which covers the torso of the infant and distributes the restraining force over the body mass of the infant and supports the infant underneath the arms as would occur when an attendant is catching a falling infant from behind. The walking training apparatus has unrestricted shoulder area and strictly uses a torso harness to allow the child to play without shoulder restrictions. The handle straps are adjustable in length allowing their use for different size attendants and also for use with both crawling and walking training, additionally modifying the length allows varying the amount of support offered to the infant. The adjustable handle straps adjust to the parent's height to reduce back pain because the parent will not have to bend over and will be able to adjust the straps to their height. The handles of the present invention also removable which allows the infant to play with reduced probability of catching the restraint on an object. The benefit of the comfort cushion is to provide a cushion for the baby's comfort at the baby's armpits. If the comfort cushion does not exist, the baby's underarms/armpits would become sore when using the invention. The removable handles also make the straps shorter which is safer for the baby and minimizes entanglement risks. Another benefit of the present invention is that without a shoulder harness or other restraints the baby is allowed to balance naturally when learning to walk which is a benefit that has been noted by pediatricians.

In view of the foregoing disadvantages inherent in the known types of devices used to train infants to walk now present in the prior art, the present embodiment of the invention provides an improved walking training apparatus, and overcomes the above-mentioned disadvantages and drawbacks of the prior art. As such, the general purpose of the present embodiment of the invention, which will be described subsequently in greater detail, is to provide a new and improved walking training apparatus and method which has all the advantages of the prior art mentioned heretofore and many novel features that result in a walking training apparatus which is not anticipated, rendered obvious, suggested, or even implied by the prior art, either alone or in any combination thereof.

To attain this, the present embodiment of the invention is a walking training apparatus having a support vest, the support vest having a top end, the support vest having a bottom end, the support vest having a back side, the support vest having a left side, the support vest having a right side, the support vest is adapted to be fitted around the torso of an infant, the support vest having a left bell shaped attachment projection, the support vest having a right bell shaped attachment projection, a left upper strap, the left upper strap connected to the support vest top end left bell shaped attachment projection and a right upper strap, the right upper strap connected to the support vest top end right bell shaped attachment projection.

In another embodiment of the invention, a walking training apparatus having a support vest, the support vest having a top end, the support vest having a bottom end, the support vest having a back side, the support vest having a left side, the support vest having a right side, the support vest is adapted to be fitted around the torso of an infant, the support vest having a left bell shaped attachment projection, the support vest having a right bell shaped attachment projection, a left upper strap, the left upper strap connected to the support vest top end left bell shaped attachment projection, a right upper strap, the right upper strap connected to the support vest top end right bell shaped attachment projection, a left handle buckle connected to the left upper strap, a right handle buckle connected to the right upper strap, a left handle detachably connected to the left handle buckle and a right handle detachably connected to the right handle buckle.

In a further embodiment of the invention, a walking training apparatus having a support vest, the support vest having a top end, the support vest having a bottom end, the support vest having a back side, the support vest having a left side, the support vest having a right side, the support vest is adapted to be fitted around the torso of an infant, the support vest having a left bell shaped attachment projection, the support vest having a right bell shaped attachment projection, a left upper strap, the left upper strap connected to the support vest top end left bell shaped attachment projection, a right upper strap, the right upper strap connected to the support vest top end right bell shaped attachment projection, a left handle buckle connected to the left upper strap, a right handle buckle connected to the right upper strap, a left handle detachably connected to the left handle buckle, a right handle detachably connected to the right handle buckle, a left vest strap connected to the support vest left side, a left belt loop connected to the left vest strap, a right vest strap connected to the support vest right side, a right belt loop connected to the right vest strap, a support vest buckle connected to the support vest left side, the support buckle connected to the vest right side, a vest cushion pad connected the support vest adjacent to the support vest top end, a left handle cushion pad connected the left handle, a right handle cushion pad connected the right handle, a left strap loop connected the left upper strap and a right strap loop connected the right upper strap.

There has thus been outlined, rather broadly, the more important features of the embodiment of the invention in order that the detailed description thereof that follows may be better understood and in order that the present contribution to the art may be better appreciated.

The present embodiment of the invention may also include a left handle buckle, a right handle buckle, a left handle, a right handle, a left vest strap, a right vest strap, a support vest buckle, a vest cushion pad, a left handle cushion pad, a right handle cushion pad, a left strap loop and a right strap loop. There are, of course, additional features of the present embodiment of the invention that will be described hereinafter and which will form the subject matter of the claims attached.

Numerous objects, features and advantages of the present embodiment of the invention will be readily apparent to those of ordinary skill in the art upon a reading of the following detailed description of presently preferred, but nonetheless illustrative, embodiments of the present embodiment of the invention when taken in conjunction with the accompanying drawings. In this respect, before explaining the current embodiment of the embodiment of the invention in detail, it is to be understood that the embodiment of the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present embodiment of the invention.

It is therefore an object of the present embodiment of the invention to provide a new and improved walking training apparatus that has all of the advantages of the prior art devices used to train infants to walk and none of the disadvantages.

It is another object of the present embodiment of the invention to provide a new and improved walking training apparatus that may be easily and efficiently manufactured and marketed.

An even further object of the present embodiment of the invention is to provide a new and improved walking training apparatus that has a low cost of manufacture with regard to both materials and labor, and which accordingly is then susceptible of low prices of sale to the consuming public, thereby making such walking training apparatus economically available to the buying public.

Still another object of the present embodiment of the invention is to provide a new walking training apparatus that provides in the apparatuses and methods of the prior art some of the advantages thereof, while simultaneously overcoming some of the disadvantages normally associated therewith.

Even still another object of the present embodiment of the invention is to provide a walking training apparatus for walking training apparatus having adjustable detachable handles.

Still yet another object of the present embodiment of the invention is to provide a walking training apparatus for walking training apparatus having detachable handles.

Further still another object of the present embodiment of the invention is to provide a walking training apparatus for walking training apparatus having no shoulder straps and using torso and under arm support.

Yet further still another object of the present embodiment of the invention is to provide a walking training apparatus for walking training apparatus having adjustable handle straps.

Lastly, an object of the present embodiment of the invention is to provide a walking training apparatus for walking training apparatus having handle strap belt loops for securing excess strap material.

These together with other objects of the embodiment of the invention, along with the various features of novelty that characterize the embodiment of the invention, are pointed out with particularity in the claims annexed to and forming a part of this disclosure. For a better understanding of the embodiment of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The embodiment of the invention will be better understood and objects other than those set forth above will become apparent when consideration is given to the following detailed description thereof. Such description makes reference to the annexed drawings wherein:

FIG. 1 is a front perspective view of the preferred embodiment of the walking training apparatus constructed in accordance with the principles of the present invention.

FIG. 2 is a rear perspective view of the walking training apparatus of the present embodiment of the invention.

FIG. 3 is a front perspective view of the walking training apparatus of the present embodiment of the invention.

FIG. 4 is a left side perspective view of the walking training apparatus of the present embodiment of the invention.

FIG. 5 is a rear perspective view of the walking training apparatus of the present embodiment of the invention.

The same reference numerals refer to the same parts throughout the various figures.

### DETAILED DESCRIPTION OF THE INVENTION

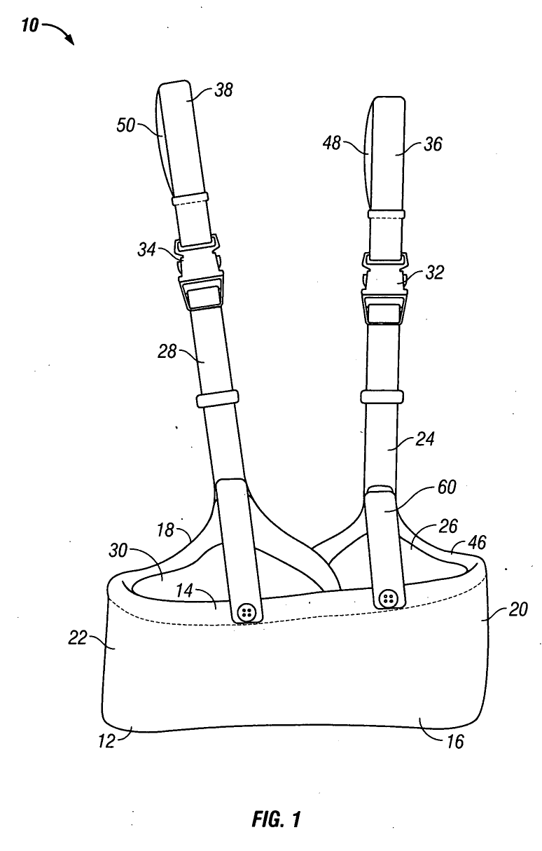

Referring now to the drawings, and particularly to FIGS. 1-5, a preferred embodiment of the walking training apparatus of the present invention is shown and generally designated by the reference numeral 10.

In FIG. 1, a new and improved walking training apparatus 10 of the present invention for walking training apparatus having adjustable detachable handles and bell shaped attachments for the handle strap is illustrated and will be described. More particularly, the walking training apparatus 10 has a support vest 12 having a top end 14, a bottom end 16, a back side 18, a left side 20 and a right side 22. The support vest 12 is adapted to be fitted around the torso of the infant. A left upper strap 24 is connected to the support vest top end left side at a left bell shaped attachment projection 26. A right upper strap 28 is connected to the support vest top end right side at a right bell shaped attachment projection 30. A left handle buckle 32 is connected to the left upper strap 24. A right handle buckle 34 is connected to the right upper strap 28. A left handle 36 is detachably connected to the left handle buckle 32. A right handle 38 is detachably connected to the right handle buckle 34. A vest cushion pad 46 is connected the support vest 12 adjacent to the support vest top end 14. A left handle cushion pad 48 is connected the left handle 36. A right handle cushion pad 50 is connected the right handle 38. A pair of removable shoulder straps 60 are also shown in FIG. 1. The removable shoulder straps 60 are optional, and are removably attached to the support vest 12 by buttons in the current embodiment, but those skilled in the art will readily appreciate that a variety of methods may be employed.

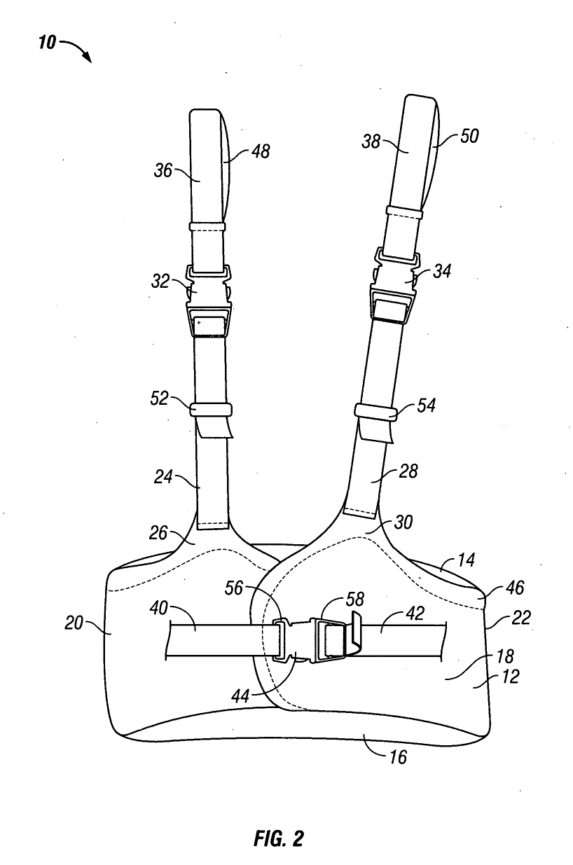

In FIG. 2, the walking training apparatus 10 of the present invention for walking training apparatus is illustrated and will be described. More particularly, the walking training apparatus 10 has the support vest 12 having the top end 14, the bottom end 16, the back side 18, the left side 20 and the right side 22. The support vest 12 is adapted to be fitted around the torso of the infant. The left upper strap 24 is connected to the support vest top end left side at the left bell shaped attachment projection 26. The right upper strap 28 is connected to the support vest top end right side at the right bell shaped attachment projection 30. The left handle buckle 32 is connected to the left upper strap 24. The right handle buckle 34 is connected to the right upper strap 28. The left handle 36 is detachably connected to the left handle buckle 32. The right handle 38 is detachably connected to the right handle buckle 34. A left vest strap 40 is connected to the support vest left side 20. A left belt loop 56 is connected to the left vest strap 40. A right vest strap 42 is connected to the support vest right side 22. A right belt loop 58 is connected to the right vest strap 42. A support vest buckle 44 is connected to the support vest left side 20 and to the vest right side 22. The vest cushion pad 46 is connected the support vest 12 adjacent to the support vest top end 14. The left handle cushion pad 48 is connected the left handle 36. The right handle cushion pad 50 is connected the right handle 38.

A left strap loop 52 connected the left upper strap 24. A right strap loop 54 is connected the right upper strap 28.

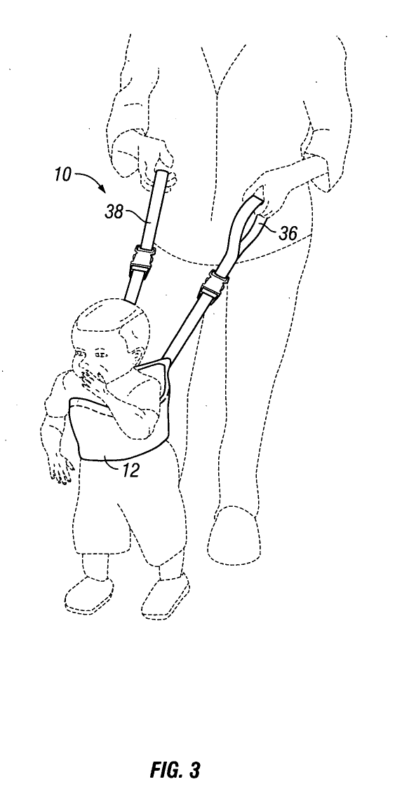

In FIG. 3, the walking training apparatus 10 of the present invention for walking training apparatus is illustrated and will be described. In this figure the invention is seen in use held by an adult with the support vest 12 on the infant. The adult holding the left handle 36 and the right handle 38.

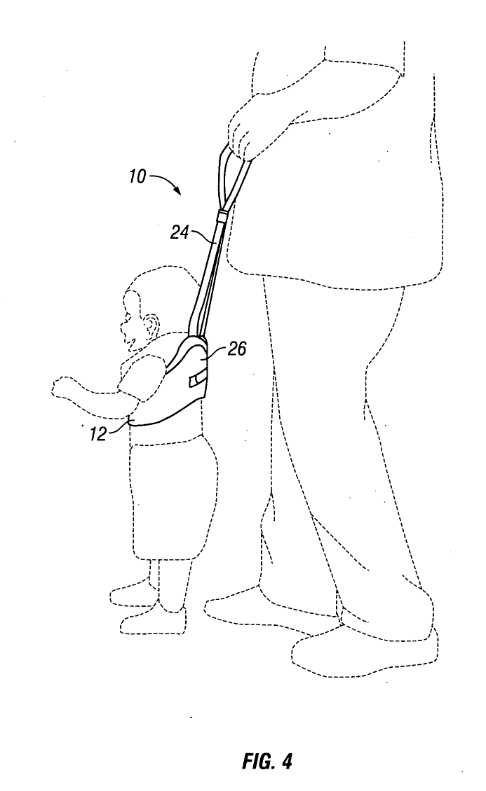

In FIG. 4, the walking training apparatus 10 of the present invention for walking training apparatus is illustrated and will be described. In this figure the invention is seen in use held by an adult with the support vest 12 on the infant. The adult holding the left handle 36. The left upper strap 24 being connected to a bell shaped connection distributes the force of restraining a falling infant over the entire torso section and not just from one point.

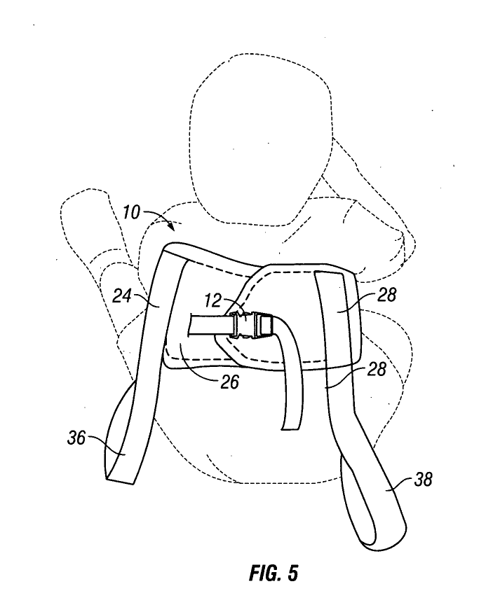

In FIG. 5, the walking training apparatus 10 of the present invention for walking training apparatus is illustrated and will be described. In this figure the invention is seen in use with the support vest 12 on the infant. The left upper strap 24 and the right upper strap 28 distribute the force of restraining a falling infant over the entire torso section.

Size and Age Requirements:

Minimum: 19″ Chest Circumference (6 months)

Maximum: 26″ Chest Circumference (2 years)

Minimum Strap Length: 12 inches

Maximum Strap Length: 24 inches

Key Benefits of the Walking Training Apparatus

| Baby's: | Parent's and Caregiver's: |
|---|---|
| Develop a sense of independence | Worry less - baby experiences |
| Gain self-confidence while | fewer falls |
| learning to walk | Avoid the back pain associated |
| Experience fewer falls and | with teaching a baby to walk |
| recover from falls more easily | Easy to use and take anywhere |
| Balance more naturally with | Small and portable product |
| two hands free | Delight in watching your baby take |
| | their first steps with confidence |

In use it can now be seen that, to use the walking training apparatus adjust both handle straps to a comfortable length. With the infant seated, securely fasten the support vest around the upper part of the infant's chest just below the armpits with both the hook and loop and safety buckle. The vest buckle and hook and loop attachments should be positioned at the back with the straps on the top. At the back of the support vest, tighten the adjustable left vest strap and right vest strap to securely fit the infant. Ensure that the support vest fits snuggly, but comfortably around the infant's chest and does not slide more than one quarter inch in any direction. Make any further adjustments to the handle straps to comfortably meet your height. After securely fastening the walking training apparatus on the infant, hold the straps straight above the infant's shoulders. This will support the infant in an upright standing position while taking their first unsteady steps.

While a preferred embodiment of the walking training apparatus has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present embodiment of the invention. For example, any suitable material may be used instead of the washable material described.

Therefore, the foregoing is considered as illustrative only of the principles of the embodiment of the invention. Further, since numerous modifications and changes will readily occur to those skilled in the art, it is not desired to limit the embodiment of the invention to the exact construction and operation shown and described, and accordingly, all suitable modifications and equivalents may be resorted to, falling within the scope of the embodiment of the invention.

What is claimed is:

1. A walking training apparatus comprising:
a support vest, the support vest having a top end, the support vest having a bottom end, the support vest having a back side, the support vest having a left side, the support vest having a right side, the support vest is adapted to be fitted around the torso of an infant, the support vest having a left bell shaped attachment projection, the support vest having a right bell shaped attachment projection;
a left upper strap connected to the support vest top end left bell shaped attachment projection; and
a right upper strap connected to the support vest top end right bell shaped attachment projection.

2. The walking training apparatus of claim 1 further comprising:
a left handle buckle connected to the left upper strap.

3. The walking training apparatus of claim 2 further comprising:
a left handle detachably connected to the left handle buckle.

4. The walking training apparatus of claim 3 further comprising:
a left handle cushion pad connected the left handle.

5. The walking training apparatus of claim 1 further comprising:
a right handle buckle connected to the right upper strap.

6. The walking training apparatus of claim 5 further comprising:
a right handle detachably connected to the right handle buckle.

7. The walking training apparatus of claim 6 further comprising:
a right handle cushion pad connected the right handle.

8. The walking training apparatus of claim 1 further comprising:
a left vest strap connected to the support vest left side; and
a left belt loop connected to the left vest strap.

9. The walking training apparatus of claim 8 further comprising:
a right vest strap connected to the support vest right side; and
a right belt loop connected to the right vest strap.

10. The walking training apparatus of claim 9 further comprising:
a support vest buckle connected to the support vest left side, the support buckle connected to the vest right side.

11. The walking training apparatus of claim 1 further comprising:
a vest cushion pad connected the support vest adjacent to the support vest top end.

12. The walking training apparatus of claim 1 further comprising:
a left strap loop connected the left upper strap; and
a right strap loop connected the right upper strap.

13. A walking training apparatus comprising:
a support vest, the support vest having a top end, the support vest having a bottom end, the support vest having a back side, the support vest having a left side, the support vest having a right side, the support vest is adapted to be fitted around the torso of an infant, the support vest having a left bell shaped attachment projection, the support vest having a right bell shaped attachment projection;
a left upper strap connected to the support vest top end left bell shaped attachment projection;
a right upper strap connected to the support vest top end right bell shaped attachment projection;
a left handle buckle connected to the left upper strap;
a right handle buckle connected to the right upper strap;
a left handle detachably connected to the left handle buckle; and
a right handle detachably connected to the right handle buckle.

14. The walking training apparatus of claim 13 further comprising:
a left vest strap connected to the support vest left side;
a left belt loop connected to the left vest strap;
a right vest strap connected to the support vest right side; and
a right belt loop connected to the right vest strap.

15. The walking training apparatus of claim 14 further comprising:
a support vest buckle connected to the support vest left side, the support buckle connected to the vest right side.

16. The walking training apparatus of claim 15 further comprising:
a vest cushion pad connected the support vest adjacent to the support vest top end.

17. The walking training apparatus of claim 16 further comprising:
a left handle cushion pad connected the left handle; and
a right handle cushion pad connected the right handle.

18. The walking training apparatus of claim 17 further comprising:
a left strap loop connected the left upper strap; and
a right strap loop connected the right upper strap.

19. The walking training apparatus of claim 18 further comprising:
a pair of shoulder straps removably attached to said support vest.

20. A walking training apparatus comprising:
a support vest, the support vest having a top end, the support vest having a bottom end, the support vest having a back side, the support vest having a left side, the support vest having a right side, the support vest is adapted to be fitted around the torso of an infant, the support vest having a left bell shaped attachment projection, the support vest having a right bell shaped attachment projection;
a left upper strap connected to the support vest top end left bell shaped attachment projection;
a right upper strap connected to the support vest top end right bell shaped attachment projection;
a left handle buckle connected to the left upper strap;
a right handle buckle connected to the right upper strap;
a left handle detachably connected to the left handle buckle;
a right handle detachably connected to the right handle buckle;
a left vest strap connected to the support vest left side;
a left belt loop connected to the left vest strap;
a right vest strap connected to the support vest right side;
a right belt loop connected to the right vest strap;
a support vest buckle connected to the support vest left side, the support buckle connected to the vest right side;
a vest cushion pad connected the support vest adjacent to the support vest top end;
a left handle cushion pad connected the left handle;
a right handle cushion pad connected the right handle;
a left strap loop connected the left upper strap; and
a right strap loop connected the right upper strap.
